(19) United States
(12) Patent Application Publication
(10) Pub. No.: US 2022/0193809 A1
(43) Pub. Date: Jun. 23, 2022

(54) TIG-TYPE METHOD FOR TACK WELDING TWO METAL SHEETS OR PARTS, CORRESPONDING WELDING METHOD AND WELDING UNIT

(71) Applicant: GYS, SAINT-BERTHEVIN (FR)

(72) Inventors: Bruno Bouygues, PARIS (FR); Mario Laverda, LAVAL (FR)

(21) Appl. No.: 17/553,003

(22) Filed: Dec. 16, 2021

(30) Foreign Application Priority Data
Dec. 17, 2020 (FR) 2013496

(51) Int. Cl. B23K 9/167; B23K 9/09; B23K 9/10

(52) U.S. Cl. CPC B23K 9/167; B23K 9/1012; B23K 9/091

(57) ABSTRACT

A TIG-type method for tack welding two metal sheets or parts, such as tubes. The method includes, for each zone/point of tack welding of the metal sheets or of the tubes, a tack welding cycle including successively applying at least one smooth or pulsed direct current DC, and then at least one smooth or pulsed alternating current AC.

### FIELD OF THE INVENTION

The present invention relates to the field of tack welding and welding of the TIG type (standing for Tungsten Inert Gas) used for tack welding and/or welding two metal sheets or parts, at least one of which is made from aluminium, an aluminium alloy or a light alloy, in particular.

The tack welding and welding technique of the present invention is particularly, but not exclusively, adapted to the automobile, aeronautical, industrial pipework and boilermaking/metalworking fields.

More precisely, the present technique proposes a judicious selection of the spot-welding/welding parameters in order to secure together two sheet metals or parts easily and rapidly, without having to use to a weld material.

### PRIOR ART

Tack welding is a specific welding operation that, prior to the complete welding of the parts together, consists in producing, all along the joints to be welded, short beads or spots of weld metal in order to hold together the parts to be assembled. Tack welding also makes it possible to maintain a constant separation of the edges of the parts to be welded and to limit any deformations of the parts during welding.

Tack welding parts made from steel or stainless steel (known by the abbreviation SS) by welding of the TIG type has been known and mastered for many years. This operation is generally performed by applying direct current (DC).

However, this principle of tack welding/welding of the TIG type with direct current DC does not operate when a sheet made from aluminium, aluminium alloy or light alloy in particular must be tack welded/welded.

For example, for aluminium, the layer of alumina that results from natural oxidation of aluminium has a melting point of around 2070° C., while aluminium has a melting point that is of the order of 660° C. It is this difference in melting point that requires reversals of polarity, in order to break the layer of alumina in order then to make it possible to melt the aluminium. Thus a sheet made from aluminium alloy requires the use of an alternating current (AC) to be welded.

Moreover, in order to optimise the time for performing tack welding/welding operations, for the purpose of gaining in productivity, the applicant has the intention of not using any weld metal for performing these operations.

However, the TIG-type tack welding of aluminium alloy sheets by applying a simple pulse of alternating current AC, without adding weld metal, does not make it possible to effectively secure together two metal sheets.

This is because welding aluminium is extremely complex without any weld metal since the reversals of polarity of the alternating current disturb the electric arc. The alternating-current AC electric arc is therefore not as stable as with a direct current DC, which greatly complexifies the tack welding or welding operations.

The current solutions for tack welding sheets of aluminium alloy or light alloy are therefore relatively complex, time consuming and generally reserved for highly competent and experienced welding operators.

The current solutions for tack welding metal sheets, in particular those made from aluminium alloy, are therefore not satisfactory.

There is therefore a need to provide a solution for TIG-type tack welding and welding of two metal sheets, at least one of which is made from aluminium, aluminium alloy or light alloy in particular, which is rapid and simple to implement, without requiring any weld material.

### SUMMARY OF THE INVENTION

The present technique makes it possible to solve at least some of the drawbacks raised by the prior art. More precisely, the present technique relates to a method for the TIG-type tack welding of two metal sheets or parts (tubes for example), said method comprising, for each zone or spot of tack welding said metal sheets or said tubes, a tack-welding cycle comprising successively the application of at least one smooth or pulsed direct current DC and of at least one smooth or pulsed alternating current AC.

After numerous tests and researches carried out, the applicant concluded that the successive application of at least one direct current and then of at least one alternating current in TIG tack welding/welding afforded an astonishingly effective tack welding of a sheet of aluminium, aluminium alloy or light alloy in particular, without using any weld metal.

The succession of the various currents is selected according to the material and of the thickness of the metal sheets to be tack welded/welded.

The method can thus use a first sequence of smooth or pulsed direct current DC, then optionally one or more other sequences of smooth or pulsed direct current DC, followed by a sequence or of a plurality of sequences of smooth or pulsed alternating current DC.

A smooth direct current may for example comprise a phase of gradual increase of the current to a threshold value and then a phase of maintaining the current at this threshold value before a last phase of current drop.

A pulsed direct current keeps the same polarity, positive or negative (unlike an alternating current, the polarity of which varies), with a variable welding intensity.

A pulsed direct current may for example comprise a phase of gradual increase of the current to a threshold value and then a phase of variation of the current in the form of a square signal (square wave) around this threshold value, before a last phase of current drop.

A pulsed alternating current is not purely sinusoidal or square for example but exhibits pulses around top and bottom end values.

According to a particular aspect of the invention, the tack welding cycle comprises:
a first sequence of applying a smooth direct current DC for a first predetermined duration and a second sequence of applying a pulsed direct current DC for a second predetermined duration, or vice versa; and
a third sequence of applying a pulsed alternating current AC for a third predetermined duration.

The present technique is particularly adapted for a tack welding method in which at least one of said metal sheets or one of said parts is made from aluminium, an aluminium alloy or a light alloy in particular.

According to a particular aspect of the present invention, said tack welding cycle comprises:
a first sequence of applying a smooth direct current DC for a first predetermined duration;
a second sequence of applying a pulsed direct current DC for a second predetermined duration; and
a third sequence of applying a pulsed alternating current AC for a third predetermined duration.

It is the particular series of these three particular sequences of current that makes it possible to obtain optimum tack welding that is simple to implement, whatever the experience of the welding operator.

More precisely, the first sequence of applying a smooth direct current DC makes it possible to pre-heat the metal sheet to be assembled and to begin to weaken the layer of alumina, during the tack welding/welding of a sheet or aluminium or aluminium alloy for example.

The second sequence of applying a pulsed direct current DC makes it possible to obtain a required heating precision that is optimum and a constriction of the electric arc with greater precision.

The third sequence of applying a pulsed alternating current AC makes it possible to maintain the precision of the electric arc and to avoid the electric arc being attracted by one part rather than the other for the purpose of precisely fusing the junction of the two metal sheets to be assembled.

According to another aspect, said first, second and third sequences are implemented successively and in this order, and said tack welding cycle has a duration of less than or equal to 2 seconds.

The successive implementation of the current sequences in this particular period of time allows rapid, simple and precise tack welding that can be implemented by welding operators of all levels.

According to one aspect of the present invention, the value of said smooth direct current of the first sequence is between 1 and 500 amperes (A).

According to another aspect, said first predetermined duration of said smooth direct current is between 10 and 1000 ms.

These values relating to the first sequence of applying a smooth direct current DC were judiciously selected by the applicant in order to pre-heat the metal sheet to be assembled and to begin to weaken the layer of alumina, during the tack welding/welding of a sheet of aluminium or aluminium alloy.

According to another aspect of the present invention, said pulsed direct current of the second sequence has a base current of between 1 and 500 amperes and a peak current of between 2 and 500 amperes.

According to another aspect, said pulsed direct current has a frequency of between 1 Hz and 20 kHz.

According to yet another aspect, said second predetermined duration of said pulsed direct current is between 10 and 1000 ms.

These values relating to the second sequence of applying a pulsed direct current DC were judiciously selected by the applicant in order to obtain a required precision of heating that is optimum and a greater precision of the electric arc.

According to yet another aspect of the present invention, said pulsed alternating current of the third sequence oscillates between approximately 1 and 500 amperes (A) and has a frequency of between 20 and 500 Hz.

According to another aspect, said pulsed alternating current varies between a base current of between 1 and 500 amperes (A) and a peak current of between 2 and 500 amperes (A).

According to yet another aspect, said pulsed alternating current is pulsed or generated at a frequency of between 1 and 20 kHz.

According to yet another aspect, said third predetermined duration of said pulsed alternating current is between 10 and 1000 ms.

These values relating to the third sequence of applying a pulsed alternating current AC were judiciously selected by the applicant in order not to lose the benefits of the pulsed direct current DC, i.e. in order to maintain the precision of the electric arc and to avoid the electric arc being attracted by one part more than the other for the purpose of precisely fusing the junction of the two metal sheets to be assembled.

The present technique also relates to a method for the TIG-type welding of two metal sheets or parts (tubes for example), at least one of said metal sheets or parts being made from aluminium, aluminium alloy or a light alloy in particular, said welding method comprising the repetition of the tack welding cycle of the tack welding method described above on at least a part of the junction between said metal sheets or said parts.

The welding method is thus a repetition of the tacking cycle.

In a particularly advantageous embodiment, the welding method may refrain from the pre-gas and post-gas sequences between each tack welding cycle comprising the three current sequences specific to the invention.

The present technique furthermore relates to a welding unit of the TIG type comprising a current generator able to implement said tack welding method described previously.

Advantageously, this unit is able to implement the welding of said metal sheets or of said parts after tack welding thereof.

Such a unit allows the tack welding of the metal sheets or parts before welding thereof, i.e. producing welding spots that hold the parts to be assembled before the welding operation.

### LIST OF FIGURES

The technique proposed, as well as the various advantages that it presents, will be understood more easily in the light of the following description of illustrative and non-limitative embodiments thereof, and the accompanying drawings, among which:

FIG. 1 is a graph showing the operation of a generator during a tack welding cycle according to a particular embodiment of the proposed technique;

FIG. 2 is a simplified diagram of the tack welding method of FIG. 1;

FIG. 3 is a graph showing the operation of a generator during a welding cycle according to a first embodiment of the proposed technique;

FIG. 4 is a simplified diagram of the welding method according to FIG. 3;

FIG. 5 is a graph showing the operation of a generator during a tack welding cycle according to a preferential embodiment of the proposed technique;

FIG. 6 is a simplified diagram of the tack welding method of FIG. 5;

FIG. 7 is a graph showing the operation of a generator during a welding cycle according to a preferential embodiment of the proposed technique; and

FIG. 8 is a simplified diagram of the welding method of FIG. 7.

FIG. 9 is a simplified diagram of a welding unit configured to implement the welding method according to an exemplary embodiment of the present application.

### DETAILED DESCRIPTION OF THE INVENTION

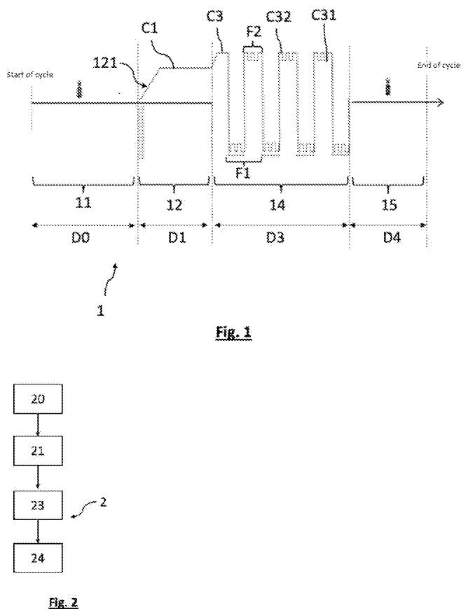

Several embodiments of the proposed technique are illustrated hereinafter, treated as simple illustrative and non-limitative examples, in support of FIGS. 1 to 8. The identical signals/steps in the various embodiments have the same numerical reference and are not described in detail at each occurrence in order to facilitate the reading and understanding of the present description.

The present technique aims to provide a TIG-type tack welding and welding solution for securing together two metal sheets, or parts (tubes, for example), that are applied against each other and at least one of which is, for example, made from aluminium, an aluminium alloy or a light alloy, such as brass.

Preferably, the metal sheets to be tack welded/welded have a thickness of between 0.4 mm and 6 mm.

More precisely, the present technique consists of applying a current cycle judiciously selected/defined following numerous tests and researches performed in this field by the applicant. This particular current cycle generally consists of associating a direct current DC and an alternating current AC in order to obtain an optimal tack welding or welding result.

More particularly, the present technique relates to a TIG-type method for tack welding two metal sheets or two parts, such as tubes, comprising, for each tack welding zone or spot and according to the material and the thickness of the metal sheets, a tack welding cycle comprising successively the application of at least one smooth or pulsed direct current DC, and then at least one smooth or pulsed alternating current AC.

Smooth direct current means a substantially constant current that can optionally have a ramp making it possible to reach a target value of the smooth current. Pulsed direct current means a current the voltage of which is variable. In particular, a pulsed direct-current supply provides a current with a single polarity with a variable voltage. Thus, unlike alternating current, the polarity of the pulsed direct current does not change. Like the traditional direct current, the pulsed direct current therefore keeps a single polarity, positive or negative.

FIG. 1 illustrates a particular embodiment of the tack welding cycle 1 according to the present technique comprising two sequences, namely the application of a smooth direct current C1 followed by the application of a pulsed alternating current C3. This particular cycle makes it possible to obtain a tack welding and/or, when it is repeated on the welding joint (in other words the junction between the two metal sheets), a precise and effective welding.

Conventionally, this tack welding cycle 1 comprises a pre-gas sequence 11 the function of which is to purge the welding torch pipe and to provide an inert atmosphere before initiation.

This pre-gas sequence 11 has a duration D0 of between 10 and 1000 ms.

The pre-gas sequence 11 is followed by the application of a smooth direct current DC C1 and then a pulsed alternating current AC C3.

More precisely, the tack welding cycle 1 comprises a sequence 12 of applying a smooth direct current DC C1. This sequence 12 has a rising ramp 121 that provides a gradual increase in the welding current to its nominal value. This first sequence 12 of applying a smooth direct current DC C1 favours the initiation of the electric arc.

The value of the smooth direct current DC C1 is between 1 and 500 amperes. This sequence 12 of applying a smooth direct current DC C1 has a duration of between 10 and 1000 ms. The rising ramp 121 for its part has a duration of between 10 and 1000 ms.

The duration D1 varies according to the material and the thickness of the metal sheets to be tack welded/welded. However, this duration D1 is relatively short in order to allow an adjustment of the intensity to a very high value, without piercing/passing through the metal sheet or sheets.

The sequence 12 of applying a smooth direct current DC C1 is followed by a sequence 14 of applying a pulsed alternating current AC C3, which makes it possible to perform the operation of tack welding or welding of the aluminium alloy.

The value of the pulsed alternating current AC C3 is/oscillates between approximately 1 and 500 amperes and has a frequency F1 of between 20 and 500 Hz.

This sequence 14 of pulsed alternating current AC C3 varies between a base current C31 of between 1 and 500 amperes and a peak current C32 of between 2 and 500 amperes.

This pulsed alternating current AC C3 is pulsed/generated at a frequency F2 of between 1 Hz and 20 kHz and has a duration D3 of between 10 and 1000 ms.

This pulsed alternating current AC makes it possible to have a constriction of the electric arc making it possible to obtain optimum precision.

This sequence of pulsed alternating current AC C3 makes it possible to ensure good precision of the electric arc and to avoid the electric arc being attracted by one part rather than the other for the purpose of precisely fusing the junction of the two metal sheets to be assembled.

The duration D3 of the sequence 14 of pulsed alternating current AC C3 varies according to the material and the thickness of the metal sheets to be tack welded/welded. However, this duration D3 is also relatively short in order to allow the use of high/strong welding currents, without risking piercing the metal sheet or sheets.

It is therefore this particular concatenation/series of the sequences that makes it possible to obtain an optimum tack welding that is simple to implement, whatever the experience of the welding operator.

According to the present technique, the sum of the durations D1 and D3 should not exceed 2 seconds. In other words, the sequences 12 and 14 of application of the currents C1 and C3 must follow each other without exceeding a total duration of 2 seconds.

To finish, the tack welding cycle 1 comprises, following the sequence 14 of pulsed alternating current AC C3, a post-gas sequence 15 that aims to protect the fusion bath once the welding has ended by a gas time delay. The post-gas sequence 15 also makes it possible to protect the tungsten electrode against oxidation during cooling thereof. This post-gas sequence 15 has a duration D4 of between 10 and 1000 ms.

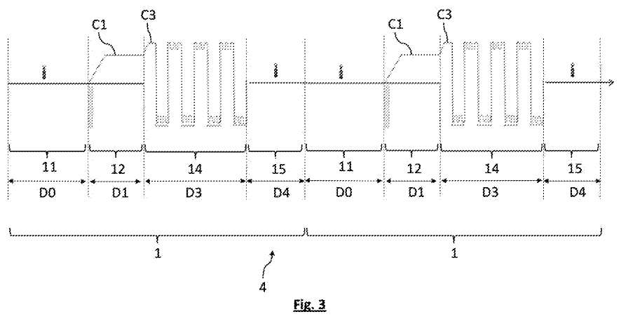

FIG. 2 is a simplified diagram of the TIG-type method for tack welding two metal sheets of FIG. 1, at least one of the metal sheets being made from aluminium alloy.

More particularly, the pointing method 2 uses the pointing cycle 1 of FIG. 1 and therefore comprises:
the application 21 of a sequence 12 of a smooth direct current DC C1 for a first predetermined duration D1; and
the application 23 of a sequence 14 of a pulsed alternating current AC C3 for a third predetermined duration D3.

As specified above, the sum of the durations D1 and D3 must not exceed 2 s (seconds).

Conventionally, these steps 21 and 23 of applying the currents C1 and C3 are preceded by a step 20 of applying a pre-gas sequence 11. They are also followed by a step 24 of applying a post-gas sequence 15.

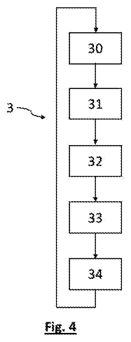

FIG. 3 partially illustrates a welding cycle 4 of the TIG type, which can be implemented following the tack welding of the two metal sheets as described previously, in order to definitively weld the latter.

According to the technique proposed, the welding cycle 4 consists of the repetition of the tack welding cycle 1 over a part or over the whole of the welding joint, i.e. the junction between the two metal sheets. In other words, once the two metal sheets are tack welded, it suffices to apply and repeat the tack welding method 2 to weld the metal sheets together.

FIG. 3 partially illustrates a welding cycle 4 since only two cycles 1 are shown. It will be understood obviously that the welding cycle 4 comprises as many tack welding cycles 1 as it is necessary to repeat to obtain the required welding.

In a variant (not illustrated), the welding cycle 4 can omit the pre-gas 11 and post-gas 15 sequences when repeating cycle 1. In this way, the welding cycle 4 is constituted by a sequence 12 of applying a smooth DC current C1 and a sequence 14 of applying a pulsed AC current C3.

FIG. 4 illustrates a welding method 3 of the TIG type according to the technique proposed. This welding method 3 is used for welding two metal sheets, at least one of the sheets being made from aluminium alloy for example.

The welding method 3 comprises the repetition of the pointing cycle 1 on at least a part or on the whole of the junction between the metal sheets.

More precisely, the welding method 3 repeats the following steps:
the application 30 of a pre-gas sequence 11;
the application 31 of a sequence 12 of a smooth direct current DC C1 for a first predetermined duration D1;
the application 33 of a sequence 14 of a pulsed alternating current AC C3 for a third predetermined duration D3; and
the application 34 of a post-gas sequence 15.

It is this particular series of the current sequences, for implementing a welding of an aluminium alloy, that makes it possible to obtain an optimum and simple welding to be achieved, whatever the experience of the welding operator.

According to a variant (not shown) of this first embodiment, the welding process 3 repeats the following steps:
applying 31 a sequence 12 of a smooth DC current C1 during a first predetermined time D1; and
applying 33 a sequence 14 of a pulsed AC current C3 for a third predetermined time D3.

According to a variant of this first embodiment, the tack welding cycle 1 comprises a smooth direct current DC, substantially identical to the current C1 described above, followed by a smooth alternating current AC.

The smooth alternating current AC has values of between 1 A and 500 A and a frequency of between 1 Hz and 400 Hz. The smooth alternating current AC makes it possible to finalise the tack welding. The change in polarity also enables us to break the layer of alumina in order to weld the aluminium sheets, for example.

According to another variant of this first embodiment, the tack welding cycle 1 comprises a pulsed direct current DC, followed by a pulsed alternating current AC substantially identical to the current C3 described above.

The value of the pulsed direct current DC varies between a base current of between 1 and 500 amperes and a peak current of between 2 and 500 amperes. This pulsed direct current DC is pulsed/generated at a frequency of between 1 Hz and 20 kHz and has a duration of between 10 and 1000 ms.

According to yet another variant of this first embodiment, the tack welding cycle 1 comprises a pulsed direct current DC, substantially identical to the pulsed direct current DC described above, followed by a smooth alternating current AC as described above.

It will obviously be understood that the principles of the tack welding method 2, of the welding cycle 4 and of the welding method 3 described above are applicable to these variants.

In a preferential embodiment of the invention, and according to the material and the thickness of the metal sheets to be tack welded/welded, the cycle comprises a first sequence of smooth direct current DC, a second sequence of pulsed direct current DC and a third sequence of pulsed alternating current AC.

This particular cycle makes it possible to obtain a tack welding and/or, when it is repeated on the welding joint (in other words the junction between the two metal sheets), a welding that is precise and effective.

The present technique facilitates the operations of tack welding and welding a metal sheet made from aluminium, aluminium alloy or a light alloy since it proves to be relatively simple in use and rapid to implement and does not require any weld metal. It is therefore within the capability of welding operators of all levels.

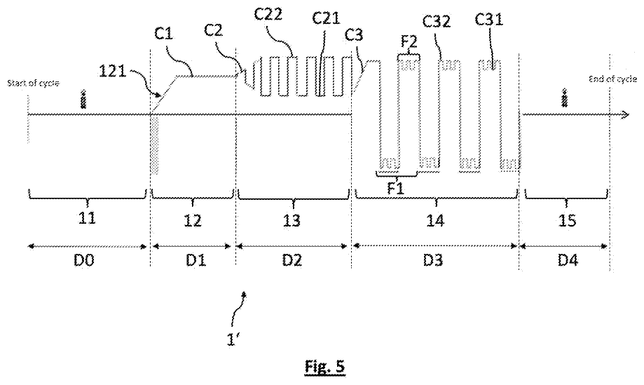

Hereinafter this preferential embodiment of the technique proposed is illustrated in support of FIGS. 5 to 8.

FIG. 5 illustrates a first cycle 1′, referred to as a tack welding cycle, of the TIG type, in order to secure together two metal sheets, at least one of which is made from aluminium, aluminium alloy or a light alloy, prior to the definitive welding of these two metal sheets.

Conventionally, this tack welding cycle 1′ comprises a pre-gas sequence 11 the function of which is to purge the pipe of the welding torch and to provide an inert atmosphere before initiation.

This pre-gas sequence 11 has a duration D0 of between 10 and 1000 ms.

The pre-gas sequence 11 is followed by the application of a direct current DC and then of an alternating current AC.

More precisely, the tack welding cycle 1′ comprises a first sequence 12 of applying a smooth direct current DC C1. This first sequence 12 has a rising ramp 121 that affords a gradual increase in the welding current to its nominal value. This first sequence 12 of applying a smooth direct current DC C1 favours the initiation of the electric arc.

Preferably, the initiation takes place at high frequency, which does not require contact of the electrode with the metal sheet. Thus there is no risk of inclusion of tungsten in the weld. In a variant, initiation at contact could also be used.

According to this embodiment, the value of the smooth direct current DC C1 is between 1 and 500 amperes. This first sequence 12 of applying a smooth direct current DC C1 has a duration D1 of between 10 and 1000 ms. The rising ramp 121 for its part has a duration of between 10 and 1000 ms.

The duration D1 varies according to the thickness of the metal sheets to be tack welded/welded. However, this duration D1 is relatively short in order to allow an adjustment of the intensity to a very high value, without piercing/passing through the metal sheet or sheets.

This first sequence 12 of applying a smooth direct current DC C1 makes it possible to pre-heat the metal sheet to be assembled and to begin to weaken the layer of alumina, during the tack welding/welding of an aluminium or aluminium alloy sheet.

The first sequence 12 of applying a smooth direct current DC C1 is followed by a second sequence 13 of applying a pulsed direct current DC C2. This second sequence 13 allows a constriction of the electric arc and an optimum concentration thereof.

According to this embodiment, the value of the pulsed direct current DC C2 varies between a base current C21 of between 1 and 500 amperes and a peak current C22 of between 2 and 500 amperes.

This second pulsed direct current C2 is pulsed/generated at a frequency of between 1 Hz and 20 kHz. This second sequence 13 of pulsed direct current DC has a duration D2 of between 10 and 1000 ms. The duration D2 also varies according to the thickness of the metal sheets to be tack welded/welded.

This selection of the applicant consisting in pulsing the electric arc makes it possible to obtain a required heating precision that is optimum. This is because, during the tack welding/welding in pulsed TIG, constricting the electric arc allows greater precision. The frequency values were selected by the applicant following numerous tests and research carried out.

The second sequence 13 of applying a pulsed direct current DC C2 is followed by a third sequence 14 of applying a pulsed alternating current AC C3, which makes it possible to perform the operation of tack welding or welding of the aluminium alloy.

According to this embodiment, the value of the pulsed alternating current AC C3 is/oscillates between approximately 1 and 500 amperes and has a frequency F1 of between 20 and 500 Hz.

This third sequence 14 of pulsed alternating current AC C3 varies between a base current C31 of between 1 and 500 amperes and a peak current C32 of between 2 and 500 amperes.

This pulsed alternating current AC C3 is pulsed/generated at a frequency F2 of between 1 Hz and 20 kHz and has a duration D3 of between 10 and 1000 ms. The duration D3 once again also varies according to the thickness of the metal sheets to be tack welded/welded.

This pulsed alternating current AC makes it possible to have a constriction of the electric arc making it possible to obtain optimum precision.

This sequence of pulsed alternating current AC C3 follows the sequence of pulsed direct current DC C2 in order not to lose the benefits of the pulsed direct current DC C2, i.e. in order to maintain the precision of the electric arc and to avoid the electric arc being attracted by one part rather than the other for the purpose of precisely fusing the junction of the two metal sheets to be assembled. The duration D3 of the sequence 14 of pulsed alternating current AC C3 is also relatively short in order to allow the use of high/strong welding currents, without risking piercing the metal sheet or sheets.

It is therefore this particular concatenation/series of the sequences 12 to 15 that makes it possible to obtain an optimum tack welding that is simple to implement, whatever the experience of the welding operator.

According to the present technique, the sum of the durations D1 to D3 must not exceed 2 seconds. In other words, the sequences 12, 13 and 14 of applying the currents C1, C2 and C3 must follow each other without exceeding a total duration of 2 seconds.

The successive implementation of the particular current sequences 12, 13 and 14 in this particular period of time has the advantage of successively pre-heating the metal sheet to be assembled, allowing a constriction of the arc and very precisely pre-heating a place on the metal sheet (i.e. the junction of the two metal sheets or tubes to be welded), and then keeping the benefit of the pulsed DC to finalise the assembly and therefore the fusion of the two elements.

To finish, the pointing cycle 1′ comprises, following the third sequence 14 of pulsed alternating current AC C3, a post-gas sequence 15 that aims to protect the fusion bath once the welding has ended by a gas time delay. The post-gas sequence 15 also makes it possible to protect the tungsten electrode against oxidation during cooling thereof.

This post-gas sequence 15 has a duration D4 of between 10 and 1000 ms.

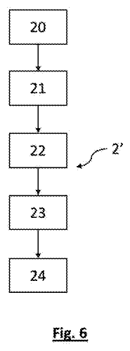

As illustrated in FIG. 6, the technique proposed also relates to a method 2′ for the TIG-type tack welding of two metal sheets, at least one of the metal sheets being made from aluminium alloy.

Preferentially, the tack welding method 2′ uses the tack welding cycle 1′ of FIG. 5 and therefore comprises:
the application 21 of a first sequence 12 of a smooth direct current DC C1 for a first predetermined duration D1;
the application 22 of a second sequence 13 of a pulsed direct current DC C2 for a second predetermined duration D2; and
the application 23 of a third sequence 14 of a pulsed alternating current AC C3 for a third predetermined duration D3.
As specified above, the sum of the durations D1 to D3 must not exceed 2 seconds.

Conventionally, these steps 21 to 23 of applying the currents C1 to C3 are preceded by a step 20 of applying a pre-gas sequence 11. They are also followed by a step 24 of applying a post-gas sequence 15.

In a variant, the steps of applying a pre-gas sequence 11 and a post-gas sequence 15 can be omitted.

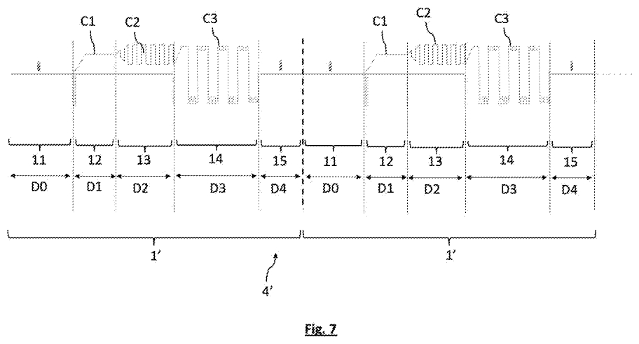

FIG. 7 partially illustrates a welding cycle 4′ of the TIG type, which can be implemented following the tack welding of the two metal sheets as described previously, in order to definitively weld the latter.

According to the technique proposed, the welding cycle 4′ consists of the repetition of the tack welding cycle 1′ over a part or over the whole of the weld joint, i.e. the junction between the two metal sheets. In other words, once the two metal sheets are tack welded, it suffices to apply and to repeat the tack welding method 2′ to weld the metal sheets together.

FIG. 7 partially illustrates a welding cycle 4′ since only two tack welding cycles 1′ are shown. It will obviously be understood that the welding cycle 4′ comprises as many tack welding cycles 1′ as it is necessary to repeat to obtain the required welding.

According to a variant (not illustrated), the welding cycle 4′ can omit the pre-gas 11 and post-gas 15 sequences during the repetition of cycle 1′. In this way, the welding cycle 4′ consists of a sequence of the first sequence 12 of application of a smooth DC current C1, the second sequence 13 of application of a pulsed DC current C2 and the third sequence 14 of application of a pulsed AC current C3.

FIG. 8 illustrates a welding method 3′ of the TIG type according to the technique proposed. This welding method 3′ is used for welding two metal sheets, at least one of the metal sheets being made from aluminium alloy.

The welding method 3′ comprises the repetition of the first cycle 1′ over at least a part or over the whole of the junction between the metal sheets.

More precisely, this welding method 3′ repeats the following steps:
the application 30 of a pre-gas sequence 11;
the application 31 of a first sequence 12 of a smooth direct current DC C1 for a first predetermined duration D1;
the application 32 of a second sequence 13 of a pulsed direct current DC C2 for a second predetermined duration D2;
the application 33 of a third sequence 14 of a pulsed alternating current AC C3 for a third predetermined duration D3; and
the application 34 of a post-gas sequence 15.

According to an alternative embodiment (not shown) of this method, the welding process 3′ repeats the following steps:
the application 31 of a first sequence 12 of a smooth DC current C1 during a first predetermined duration D1;
the application 32 of a second sequence 13 of a pulsed DC current C2 during a second predetermined time D2;
the application 33 a third sequence 14 of a pulsed AC current C3 for a third predetermined time D3; and

It is this particular concatenation/series of the sequences 12 to 14, for implementing a welding of an aluminium alloy, that makes it possible to obtain optimum welding that is simple to implement, whatever the experience of the welding operator.

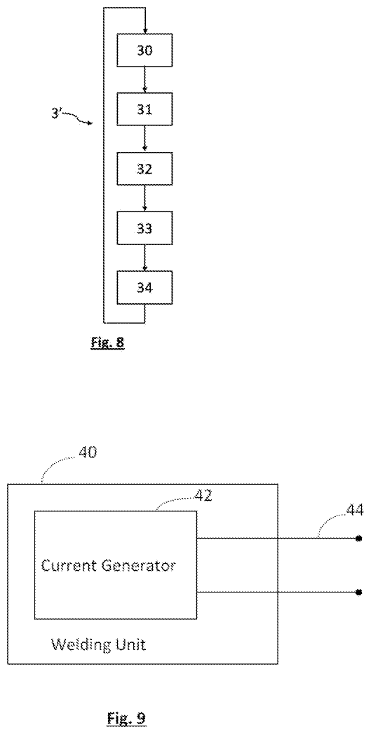

The technique proposed also relates to a welding unit 40 of the TIG type, as shown in FIG. 9, comprising a current generator 42 configured for implementing the tack welding methods 1, 1′ and welding methods 3, 3′ described previously.

Such a unit 40 allows the tack welding of metal sheets or parts before the welding thereof, i.e. it makes it possible to produce welding spots that hold the parts to be assembled before the welding operation.

Such a unit 40 further comprises, in a conventional manner, an electrode 44 used for creating an electric arc between the electrode 44 and the parts to be tack welded and welded.

In other words, the current generator 42 of the present technique is configured for generating a cycle of currents comprising successively at least one smooth or pulsed direct current DC, and then at least one smooth or pulsed alternating current AC.

Preferentially, the current generator 42 is configured for generating a current cycle comprising successively:
a first sequence 12 of a smooth direct current DC C1 for a first predetermined duration D1;
a second sequence 13 of a pulsed direct current DC C2 for a second predetermined duration D2; and
a third sequence 14 of a pulsed alternating current AC C3 for a third predetermined duration D3.

This current generator 42, configured for generating the cycle of currents specific to the technique proposed makes it possible to implement a welding of an aluminium alloy that is optimum and simple to implement, whatever the experience of the welding operator.

1. A Tungsten Inert Gas (TIG) method for tack welding first and second metal sheets or parts, said method comprising:
for each zone or point of tack welding of said first and second metal sheets or parts, implementing a tack welding cycle comprising successively applying at least one smooth or pulsed direct current, and then at least one smooth or pulsed alternating current, wherein said tack welding cycle comprises:
a first sequence of applying a first, smooth direct current for a first predetermined duration and a second sequence of applying a second, pulsed direct current for a second predetermined duration, or vice versa; and
a third sequence of applying a third, pulsed alternating current for a third predetermined duration.

2. The TIG method according to claim 1, wherein said tack welding cycle comprises:
the first sequence of applying the first, smooth direct current for the first predetermined duration;
followed by the second sequence of applying the second, pulsed direct current for the second predetermined duration;
followed by the third sequence of applying the third, pulsed alternating current for the third predetermined duration.

3. The TIG method according to claim 1, wherein at least one of said first and second metal sheets or parts is made from aluminium, an aluminium alloy or a light alloy.

4. The TIG method according to claim 1, wherein said first, second and third sequences are implemented successively and in this order, and said tack welding cycle has a duration of less than or equal to 2 seconds.

5. The TIG method according to claim 1, wherein a value of said smooth direct current is between 1 and 500 amperes.

6. The TIG method according to claim 1, wherein said first predetermined duration of said first, smooth direct current is between 10 and 1000 milliseconds.

7. The TIG method according to claim 1, wherein said second, pulsed direct current has a base current with a value of between 1 and 500 amperes and a peak current with a value of between 2 and 500 amperes.

8. The TIG method according to claim 1, wherein said second, pulsed direct current has a frequency of between 1 Hz and 20 kHz.

9. The TIG method according to claim 1, wherein said second predetermined duration of said pulsed direct current is between 10 and 1000 milliseconds.

10. The TIG method according to claim 1, wherein said third, pulsed alternating current oscillates between approximately 1 and 500 amperes and has a frequency of between 20 and 500 Hz.

11. The TIG method according to claim 1, wherein said third, pulsed alternating current varies between a base current of between 1 and 500 amperes and a peak current of between 2 and 500 amperes.

12. The TIG method according to claim 1, wherein that said third, pulsed alternating current is pulsed/generated at a frequency of between 1 Hz and 20 kHz.

13. The TIG method according to claim 1, wherein said third predetermined duration of said third, pulsed alternating current is between 10 and 1000 milliseconds.

14. The TIG method according to claim 1, further comprising:
repeating the tack welding cycle on at least a part of a junction between said first and second metal sheets or parts to weld the first and second metal sheets or parts.

15. A Tungsten Inert Gas (TIG) welding unit for tack welding first and second metal sheets or parts, the welding unit comprising:
a current generator, is configured to implement, for each zone or point of tack welding of said first and second metal sheets or parts, a tack welding cycle comprising successively applying at least one smooth or pulsed direct current, and then at least one smooth or pulsed alternating current, wherein said tack welding cycle comprises:
a first sequence of applying a first, smooth direct current for a first predetermined duration and a second sequence of applying a second, pulsed direct current for a second predetermined duration, or vice versa; and
a third sequence of applying a third, pulsed alternating current for a third predetermined duration.
